(19) United States
(12) Patent Application Publication
(10) Pub. No.: US 2006/0274653 A1
(43) Pub. Date: Dec. 7, 2006

(54) Link and communication network load with access control

(76) Inventors: Joachim Charzinski, Munchen (DE); Michael Menth, Oellingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/570,430

(22) PCT Filed: Nov. 21, 2003
(86) PCT No.: PCT/DE03/03873

§ 371 Date: Mar. 2, 2006

(30) Foreign Application Priority Data
Sep. 5, 2003 (DE) 103 19 310.3

(51) Int. Cl. H04L 12/26

(52) U.S. Cl. 370/230

(57) ABSTRACT

An overbooking according to the ratios of the measuring values of transferred aggregated traffic is determined according to the face values of aggregated transferred traffic. The ratios of measuring values in relation to face values are weighted according to the variable of either the measuring value or the face value such that with smaller measuring values and/or face values the ratios thereof have a slightly lower effect on the determination of overbooking than the ratios of greater measuring values and face values in relation to each other. Systematic access for the improved use of wave bands is provided. Representative situations, wherein a high charge of the wave band is predominant, are taken into account to a greater extent during the determination of the overbooking factor than by phases characterized by a small load.

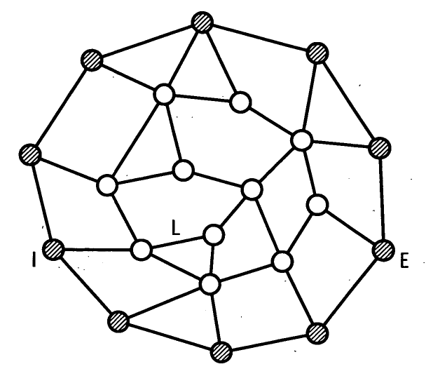

### CROSS REFERENCE TO RELATED APPLICATIONS

This application is the US National Stage of International Application No. PCT/DE2003/03873, filed Nov. 21, 2003 and claims the benefit thereof. The International Application claims the benefits of German application No. 10319310.3 DE filed Sep. 5, 2003, both of the applications are incorporated by reference herein in their entirety.

### FIELD OF INVENTION

The invention relates to a method for improving the utilization of a link in a communication network and a method for improving the utilization of a communication network.

### BACKGROUND OF INVENTION

The invention pertains to the field of network engineering and is aimed primarily at a better utilization of packet-oriented networks carrying realtime traffic.

In many of today's networks there are methods for overload control in order to ensure the quality of transmission in these networks. One possibility of overload control is to subject data traffic that is to be transferred to admission controls. In this case a bandwidth reservation is performed for registered traffic on a per-link basis or for the entire network. Newly registered connections are rejected there is no longer sufficient bandwidth available for the requested transmission service.

As a rule the entire bandwidth reserved in accordance with admission controls is higher than the bandwidth that is actually used. Networks with access controls often also use what are referred to as policers or control instances which measure the bandwidth actually used and discard packets if the reserved bandwidth is exceeded. The bandwidth reservation is therefore performed mostly in a conservative manner, so that traffic surges do not lead to the requested bandwidth being exceeded. Moreover, connections frequently have an on/off character, which is to say that there are pauses during which no data is transmitted. Finally, data streams start sending after a time delay following the setting up of the reservation.

### SUMMARY OF INVENTION

Owing to the discrepancy between the reserved bandwidth and the bandwidth actually used, more traffic is meanwhile being admitted by network operators based on measured values than the bandwidth reservation would warrant.

An object of the invention is to specify a systematic method for an improved utilization of the available transmission capacities.

The object is achieved based on a method according to the claims.

The communication network is, for example, an IP (Internet Protocol) network. The access control takes place either for at least one communication link in the network or for aggregated traffic transferred over the communication network. The access control permits only a limited quantity of data to use the network as a communication medium in order to protect it against overload. Another possibility is to subject only traffic of one (or more) traffic class(es) to an access control (the check may be applied, for example, to traffic classes for realtime traffic). Traffic not subjected to an access control will then be transmitted, for example, according to a “best effort” policy, i.e. transmission without quality-of-service features.

The invention permits more traffic to be admitted in a controlled manner on the basis of empirical values or measured values than would be admitted by the pure control method on the basis of the indicated traffic volume. According to the invention the overestimation of the indicated traffic descriptions (i.e. the bandwidth applied for according to the reservation) is at least partially evened out.

The basic idea of the method is to determine an empirical value or measured value for the data rate actually used by reservations in relation to the declared rate (nominal value). Measured values are weighted all the more heavily in this determination, the more significant they are. Toward that end, measured values from phases with a high level of utilization of the reservable budgets are taken into account to a greater extent than measured values from phases with little traffic. The ratios or, as the case may be, quotients of measured values of all the traffic transferred over the link to nominal values of all the traffic admitted for transfer over the link during the access control are weighted in accordance with the (absolute) size either of the measured value or of the nominal value. For an overbooking based on determined ratios between measured values and nominal values, those values are obviously most significant which relate to a traffic situation with a high level of utilization. A high level of utilization leads to large values for the registered accumulated traffic volume (nominal value) or the measured accumulated traffic volume (measured value). As a result of the weighting, situations with a high level of utilization are taken into account to a greater extent for the specification of an overbooking factor.

The method according to the invention leads to atypical or less frequent events being assigned a lower weighting. Thus, for example, a less conservative value can be determined for the overbooking factor, albeit one which takes account of the important events. This is necessary, for example, in order to make the determination of the overbooking factor robust in respect of atypical situations at times of low traffic volume:

For example, a connection that by chance is active on its own may require its entire reserved bandwidth. This results in the ratio of measured value to nominal value being equal to one. In the event that that is an atypical behavior, it is barely taken into account by the weighting according to the invention if the bandwidth used is small in comparison with the total bandwidth available.

An attacker could corrupt the system by holding reservations and sending substantially more than is provided by the nominal values. In this way he possibly damages the quality of service of the active connections. An action of this sort would only be likely to succeed if the attacker is able to use a large part of the existing bandwidth. If this is not the case, the attack will be intercepted by the weighting during the determination of the overbooking factor.

According to a development of the invention, the measured values are weighted such that more up-to-date measurements are taken into account to a greater extent. A weighting can be performed by multiplication of the measured values by an aging factor. For example, all the measured values are multiplied by the aging factor at fixed time intervals. Another approach is the multiplication of the old measured values by an aging factor each time a new flow is registered. In this case the aging factor can be chosen by the bandwidth reserved for the new flow.

The invention can easily be combined with different types of access control schemes which make use of indicated traffic descriptions.

The access control is performed using a limit for the aggregated traffic on the link or, as the case may be, using a limit for aggregated traffic transferred over the communication network. Which aggregated traffic in the communication network is measured and compared with a nominal value for the aggregated traffic is dependent on the access control scheme used. Three possibilities are outlined below:
The admission control is performed using a limit for the data traffic transferred between two edge points of the communication network, and the measured values and the nominal values relate to the aggregated data traffic transferred between the two edge points.
Two admission controls are performed using a limit for the data traffic entering the communication network at an edge point or using a limit for the data traffic exiting at an edge point. Data traffic is admitted if both admission controls have a positive outcome. The measured values and the nominal values then relate to the aggregated admitted data traffic, i.e. to the aggregated data traffic that entered the network at the corresponding edge point, or to the aggregated data traffic that leaves the network at the other edge point.
Two admission controls are performed in each case for each link affected by the transfer of the data traffic using a limit for the data traffic entering the communication network at an edge point or using a limit for the data traffic exiting at an edge point. Data traffic is admitted if all the admission controls have a positive outcome. The measured values and the nominal values then relate to the aggregated admitted data traffic transferred over an affected link, i.e. the aggregated data traffic transferred over the link that entered the network at the corresponding edge point, or to the aggregated data traffic transferred over the link that leaves the network at the other edge point.

However, the method according to the invention is not restricted to the above cases, but can be flexibly adapted for any access controls. In general it holds here that the limit for aggregated traffic used for the access control or the limits used lead to the measured values requiring to be determined. The nominal values for aggregated traffic are compared with the limit or limits and the measured values must correspond thereto. For example, in the last case cited above—limits that are dependent on an edge node and a link, respectively—the aggregated traffic transferred over the link can be measured, which traffic entered the network at the corresponding edge node or is to leave the network. Measured values should correlate with the limits. An unequivocal correspondence is not required in this case. Knowledge of the traffic distribution in the network and of statistical characteristics of the network can be called upon, for example, in order to reduce the number of measurements required.

In addition to a specific overbooking factor according to the invention, the following variables can be included in the specification of the limit for an access control upon registration of a flow at the network boundary:
The available bandwidth of links to be used for the transfer of the flow.
A safety factor which is chosen to be less than one and defines a safety margin for the allocation of bandwidth. A safety factor of this type can intercept, for example, transient fluctuations in flows exceeding the nominal value.
A delay limiting factor which is chosen to be less than one and which is chosen such that the delay to be expected during the transport of data packets does not exceed a chosen threshold. Experience shows that variations in the packet size and the transmission rate result in a very considerable increase in the duration of the transport or of the delay in the transport of packets through the network when the utilization of the network approaches the total capacity. By means of the delay limiting factor it is ensured that the utilization of the network (possibly for routes to be used by the registered traffic) remains below the threshold at which the delay of the data packets adversely affects the quality of the transmission.

If all the above-cited factors are used for the access control, a new flow fnew with a maximum transfer rate r(fnew) can be admitted if
r(fnew)+Σr(old)≦c(l)*θ(t)*ρ*χ,
where Σr(old) is the sum of the maximum transfer rates of the already admitted flows, c(l) is the available bandwidth on the link l, θ(t) is the overbooking factor, p is the delay limiting factor, and χ is the safety factor. An access control of this kind can be performed on a link-, route- or network-related basis.

In a communication network, the section of the network (e.g. the section between two edge nodes) for which measured values are determined can be regarded as a virtual link with access control. In this case the traffic streams run between the two edge nodes on physical links which may also provide some bandwidth for traffic streams transferred between other edge nodes. A virtual link can also include alternative physical links. A node within the network which represents a source (i.e. transmitter) or sink (i.e. receiver) for data traffic should also be understood to mean an edge node in this scenario. For traffic streams or flows or connections which are to be transferred over the link or between the edge nodes of the communication network, a check is made to determine whether the transfer of the announced volume of traffic (nominal value) would lead to the limit being exceeded.

The weighting of the ratios of measured values to nominal values can be performed using a distribution function for the weighted ratios of measured values to nominal values. In this case the weighting can be performed with the aid of a weighting function. The weighting function is, for example, proportional to the n-th power of the measured value or of the nominal value. In this case a reference value is determined for the weighted ratios in accordance with a probability value, with the result that the probability for weighted ratios of measured values to nominal values exceeding the reference value is equal to the probability value. If there are multiple values for which the probability for weighted ratios of measured values to nominal values exceeding the respective value is equal to the probability value, it makes sense to specify the reference value as the minimum or greatest lower bound of these values. This rule should be applied, for example, if the probability value is set equal to zero. In this case the reference value would be equal to the greatest occurring ratio of measured value to nominal value. A better utilization is obtained, however, if the probability value is set equal to a small, finite value. The overbooking factor can then be specified proportionally to the reciprocal value of the reference values.

Another less elaborate possibility for defining weights is to take the weight one for measured values or nominal values above a threshold and to specify the value zero for the weight below the threshold. This means that ratios of measured values to nominal values with a low absolute value of the measured value or nominal value are not taken into account for determining the overbooking factor.

According to a development a distinction is made in the method between different traffic classes. That is to say that measured values are determined as a function of traffic class and overbooking factors are determined for the different traffic classes. In this way a more conservative overbooking factor can be specified for traffic classes with high quality-of-service requirements (for example, what is referred to as realtime traffic) than for other traffic classes.

Measured values for calculating an overbooking factor can be determined for the entire network and used for calculating a network-wide overbooking factor. Alternatively, overbooking factors can be calculated on a route-dependent basis.

For example, the access control for a new flow can relate to the traffic having the same ingress and egress node as the registered flow. In this instance measured values can be determined for the links which are used by the traffic between the ingress node and the egress node, and an overbooking factor can be calculated for this traffic.

The subject matter of the invention will be explained in more detail below with reference to two exemplary embodiments. The first exemplary embodiment explains the principle of the invention with the aid of a link-related access control. In the second exemplary embodiment it is explained which changes affecting the first exemplary embodiment can be made if the access control relates to a network rather than to a link.

### BRIEF DESCRIPTION OF THE DRAWING

For this purpose an example of an access control for this network is presented with the aid of a FIGURE.

### DETAILED DESCRIPTION OF INVENTION

A number of variables are introduced below in the interests of better intelligibility and for use in formulae:
The parameter D is the average traffic volume that is supplied to the system as an offered load in what is referred to as the “busy hour”. The parameter D is assumed to be constant for a relatively long period of time, but can change over hours, days and weeks.
B is the limit or budget for the admission control. The budget B can be calculated using a traffic model on the basis of D. The calculation is made, for example, in accordance with the criterion that an incoming request will be rejected with a blocking probability of 10⁻³ only. The parameter B is, like D, fixed. If D changes, B should also be redefined in order to achieve the target specifications with regard to the blocking probability.
The variable A stores the aggregate rate of the admitted connections (i.e. the total traffic load transferred over the link) according to the indicated traffic descriptions, i.e. according to the reservation requirements. A corresponds to the nominal value of the total traffic admitted for transfer over the link. The admission is performed dynamically on request, for which reason A(t) is a time-dependent variable. Let ρ≦1 be the aimed-at maximum utilization of the resource (link capacity). Since not too much traffic may be admitted onto a link, A(t)≦θ*ρ*B(t) must apply, where θ is an overbooking parameter or overbooking factor that is determined from time to time by the method according to the invention. In this case the overbooking parameter should compensate for the fact that as a general rule the admitted connections send, not at their maximum rate, but at a lower rate. With θ>1, the reservable capacity of the resource can thus be increased.
The variable M stores the measured aggregate rate on the link, i.e. M is the measured value of the total traffic admitted for transfer over the link. Rates can be measured as transported data per unit time. A moving average over a measurement window of length IM can be used for measuring the aggregate rate. Like A(t), M(t) is a time-dependent variable. It holds that M(t)≦A(t). There are several reasons for this:
   If the actual rate of an aggregate should be greater than A(t), its packets are discarded by the policer at the edge of the network or at the node upstream of the link and its rate is thereby reduced to A(t).
   Data streams start to send with a time offset after the setting up of a reservation.
   The traffic description of a connection is specified conservatively in order to avoid losses due to rate checking in the network.
   Connections have an on/off character, i.e. they do not always have something to send.
The time-dependent variable Q(t) describes the quotient Q(t)=M(t)/A(t). Since M(t) is the measurement of the admitted and rate-controlled traffic, Q(t) should be <1 (with measurement errors not being considered). Q(t) is a measure for the inefficiency of the access control, it being necessary to note that for the above-mentioned reasons Q(t) is usually less than 1.

Since Q(t) varies over time, this variable cannot be used directly (e.g. via a choice of θ=1/Q) for overbooking. In order also to be able to maintain the required quality of service for the reservations with an overbooking factor θ>1, a reference value U is used instead of Q(t), said reference value U being exceeded only correspondingly rarely. In the simplest case U could be assumed, for example, as the time maximum of Q(t): U=maxₜQ(t). U is the maximum utilization of the system in a typical state, should represent a longer-term value and at the same time be conservative. It will be shown in the following how, according to the invention, a better value can be determined for U subject to the condition that typical measured values have the most influence on the definition of U.

If A(t) and M(t) are small compared with B, with a specification U=maxₜQ(t) few connections with an atypical M/A ratio Q(t) can have a very great impact. This is taken into account for determining U in the method according to the invention. For this purpose the M/A ratios are weighted.

As a result of the correlation of A(t) and M(t), the utilization of the reservations can be determined relatively precisely. Average values would be very imprecise, and a direct utilization of the transmission capacities would distort the picture due to the capacity of unused reservations.

The weight function W(t) assesses the significance of Q(t). For example, W(t)=M(t)ⁿ (where n is a natural number) can be chosen. In this way the size of M(t) (and via M(t)≦A(t) also A(t)) is included in the weight and correlates the latter with the significance of Q(t). For example, the number of active connections or other quantities not mentioned here can also be factored into this weight function.

The function leq is defined by

$$leq ( X , i ) = \{ \begin{matrix}1 ifX \leq i \\ 0 ifX > i\end{matrix} \} .$$

The weight W(t) is defined for Q(t) by way of a measurement function

$$R ( t ) = \frac{{\int }_{- ∞}^{t} W ( x ) ⅆ x}{{\int }_{- ∞}^{∞} W ( x ) ⅆ x} ,$$

so that a distribution function can be defined for Q, as follows:

$$\begin{matrix}P ( Q \leq u ) = {\int }_{- ∞}^{∞} leq ( Q ( t ) , u ) ⅆ R ( t ) \\ = {\int }_{- ∞}^{∞} leq ( Q ( t ) , u ) \cdot \frac{ⅆ R ( t )}{ⅆ t} ⅆ t \\ = \frac{{\int }_{- ∞}^{∞} leq ( Q ( t ) , u ) \cdot W ( t ) ⅆ t}{{\int }_{- ∞}^{∞} W ( t ) ⅆ t} .\end{matrix}$$

It holds that R(t)≦1, hence also that P(Q≦u)≦1, and therefore P(Q≦u) is a distribution that weights each continuous measured value by

$$\frac{ⅆ R ( t )}{ⅆ t}$$

and hence proportionally to W(t).

This method using continuous measured values is also adaptable to measurement methods using discrete measuring points:

$$\begin{matrix}P ( Q \leq u ) = {\sum }_{j = - ∞}^{∞} leq ( Q ( {t}_{j} ) , u \cdot ⅆ R ( {t}_{j} ) \\ = {\sum }_{j = - ∞}^{∞} leq ( Q ( {t}_{j} ) , u ) \cdot \frac{W ( {t}_{j} )}{{\sum }_{- ∞}^{∞} W ( {t}_{k} )} .\end{matrix}$$

It is assumed here that all the measurement intervals are the same length. However, the method can also be easily adapted to measurement intervals of different lengths.

With the aid of this distribution function the 1−α quantile can be used for U: U=min{u|P(Q≦u)≧1−α}. Thus, the smallest value that will be exceeded by Q only with probability α is chosen for U.

By means of the a parameter the control method can be adjusted more or less progressively. (α=0 is the most conservative choice in which the maximum of Q is used for U in each case. Greater values of α make the method less conservative, but at the same time also less reliable in respect of infringements of the assured quality of service.) As a result it can be made suitable in particular for realtime traffic.

A reliable start value for the operation of a network is θ=1. After a certain time (when sufficient statistical data is available in order to calculate U with a certain reliability), θ=1/U can be set. The value of U should be recalculated from time to time and θ adjusted accordingly. In this case either all the data from the past can be included, or a choice can be made (e.g. time window or selection of the most relevant values of Q, i.e. those in which A or M were particularly large).

Alternatively or in addition to the above described calculation of Q(t) or U(t), a weighting function can be used which completely ignores measured values from small A(t) or M(t). This step could equally be introduced in determining θ:

If A(t) or M(t) is below a specified threshold (e.g. 0.1*B), the measured value U is discarded and instead θ is left on the old value.

The parameters used for the method can be chosen as follows:

The duration of a measurement interval IM should range in the order of magnitude of less than the duration of a connection (<10 s), as otherwise some connections cannot even be recorded. However, it should also be large enough so that as many connections as possible send within this period (>500 ms). The duration of a measurement cycle should be chosen to be large enough so that sufficient statistical data is present to obtain a good estimate for U.

In addition, the method can be given more or less memory by recording the statistics for Q(t) over a longer or shorter time (multiple measurement cycles).

This method can be transferred from the access control for a pipe or a link to the access control for a network.

The FIGURE shows a communication network with access control. Edge nodes are identified by solid circles, inner nodes by open circles. Links are represented by connections between the nodes. By way of example, one ingress node is identified by I, one egress node by E, and a link by L. Some of the traffic between the nodes I and E is transferred over the link L. An access control at the ingress node I and at the egress node E ensure, in conjunction with access controls at other edge nodes, that no overload occurs at the link L. The access control is performed using a limit or a budget B(I,E) for the traffic transferred between the nodes I and E.

The method described for a link can be applied to the communication network by extending the variables to border-to-border (b2b) relationships or edge-to-edge relationships between the access node I and the egress node E. In principle, each such relationship is regarded as a virtual link.
D becomes D(I,J)
B becomes B(I,J)
A becomes A(I,J)
M becomes M(I,J). M(v,w) can be determined at the policer, for example. If this is to be done by measurements on links, however, their overall rate can be measured and allocated proportionally to all active border-to-border b2b relationships proportional to A(I,J). The maximum of these measured values, for example, could then be taken for M(I,J).
Q becomes Q(I,J).
U becomes U(I,J).

If it is assumed that the statistical properties of the traffic are the same everywhere, statistically more meaningful values can be obtained by the aggregation of border-to-border b2b relationships. In this case the variables are no longer maintained per b2b relationship but, for example, only per access router or on a network-wide basis.

1.-20. (canceled)

21. A method for improving utilization of a link for transferring traffic in a communication network, comprising:
providing an access control for data traffic of at least one traffic class to be transferred over the link via a limit for a total data traffic to be transferred over the link;
overbooking of the link via the access control, the overbooking specified in accordance with a ratio of a measured value of the total data traffic transferred over the link to a nominal value of the total data traffic to transfer over the link; and
weighting a plurality of ratios in accordance with the size of either the measured value or of the nominal value for the respective ratio,
wherein the ratio of a smaller measured value to the nominal value has a less significant effect on the specification of the overbooking than the ration of a larger measure value to the nominal value.

22. A method for improving the utilization of a communication network formed by nodes, comprising:
providing an access control for data traffic of at least one traffic class to be transferred over the link,
wherein the access control is provided by the node; and
specifying an overbooking factor in accordance with a ratio of a measured value of a transferred aggregated traffic to a nominal value of aggregated traffic that is to be transferred; and
weighting a plurality of ratios in accordance with the size of either the measured value or of the nominal value for the respective ratio,
wherein the ratio of a smaller measured value to the nominal value has a less significant effect on the specification of the overbooking than the ration of a larger measure value to the nominal value.

23. The method according to claim 22,
wherein an admission control is performed using a limit for the traffic transferred between two edge points of the network, and
wherein the measured values and the nominal values relates to the aggregated data traffic transferred between the two edge points.

24. The method according to claim 22,
wherein two admission controls are performed using a first limit for traffic entering the network at an edge node and using a second limit for traffic exiting at an edge node,
wherein traffic is admitted if both controls have a positive outcome, and
wherein the measured values and the nominal values relate to the transferred aggregated traffic.

25. The method according to claim 22,
wherein two admission controls are performed for each link affected by the transfer of the data traffic using a first limit for the traffic entering the network at an edge node and using a second limit for the data traffic exiting at an edge node,
wherein traffic is admitted if all controls have a positive outcome, and
wherein the measured values and the nominal values relate to the aggregated traffic transferred over an affected link.

26. The method according to claim 22,
wherein a distribution is defined for the weighed ratios,
wherein a reference value is determined for the weighed ratios in accordance with a probability value, and
wherein the probability for weighed ratios of measure values to nominal values exceeds the reference value.

27. The method according to claim 26,
wherein the ratios are weighted according to a function that is proportional to the nth power of the respective measured or nominal value, and
wherein n is a natural number.

28. The method according to claim 26,
wherein the ratios are weighted with a value of one when respective measured or the nominal value is above a limit, and
wherein the ratios are weighted with a value of zero when the respective measured or the nominal value is below the limit

29. The method according to claim 26, wherein the probability value is zero.

30. The method according to claim 26, wherein the overbooking factor is specified in accordance with the reciprocal value of the reference value.

31. The method according to claim 22, wherein the ratio is equal to the quotient of the measure value to the nominal value.

32. The method according to claim 23, wherein the method is performed for all pairs of ingress nodes and egress nodes of the network.

33. The method according to claim 22, wherein a safety margin is used during access control avoid a full utilization of an available bandwidth

34. The method according to claim 22, wherein a delay factor is used during access control so that a delay during the transport of the packets does not exceed a threshold.

35. The method according to claim 22, wherein an aging of the measured values used for specifying the overbooking factor is performed.

36. The method according to claim 35, wherein the aging is performed by multiplication of the measured value by an aging factor.

37. The method according to claim 22, wherein a plurality of traffic classes are used and an overbooking factor is specified for each traffic class.

38. The method according to claim 22, wherein the subset of links is given by those links which are used by traffic transferred between a fixed ingress node and a fixed egress node.
